(19) United States
(12) Patent Application Publication
(10) Pub. No.: US 2018/0087301 A1
(43) Pub. Date: Mar. 29, 2018

(54) Gate Locking System

(71) Applicants: Gerald Curry, Rushville, IL (US); Jane Curry, Rushville, IL (US)

(72) Inventors: Gerald Curry, Rushville, IL (US); Jane Curry, Rushville, IL (US)

(21) Appl. No.: 15/276,977

(22) Filed: Sep. 27, 2016

(51) Int. Cl. E05C 17/44; E05C 19/00; E06B 11/02

(52) U.S. Cl. CPC E05C 17/44; E06B 11/022; E05C 19/003

(57) ABSTRACT

A gate locking system includes a gate. The gate is selectively positioned in an open position and a closed position. A locking unit is provided. The locking unit is movably coupled to the gate and the locking unit may be manipulated. The locking unit selectively retains the gate in the open position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to locking devices and more particularly pertains to a new locking device for retaining a gate in an open position.

### BRIEF SUMMARY OF THE INVENTION

An embodiment of the disclosure meets the needs presented above by generally comprising a gate. The gate is selectively positioned in an open position and a closed position. A locking unit is provided. The locking unit is movably coupled to the gate and the locking unit may be manipulated. The locking unit selectively retains the gate in the open position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a locking unit of a gate locking system according to an embodiment of the disclosure.

FIG. 2 is an exploded perspective view of a locking unit of an embodiment of the disclosure.

FIG. 3 is a perspective in-use view of an embodiment of the disclosure showing a locking unit in a stored position.

FIG. 4 is a perspective view of an embodiment of the disclosure showing a locking unit in a deployed position.

### DETAILED DESCRIPTION OF THE INVENTION

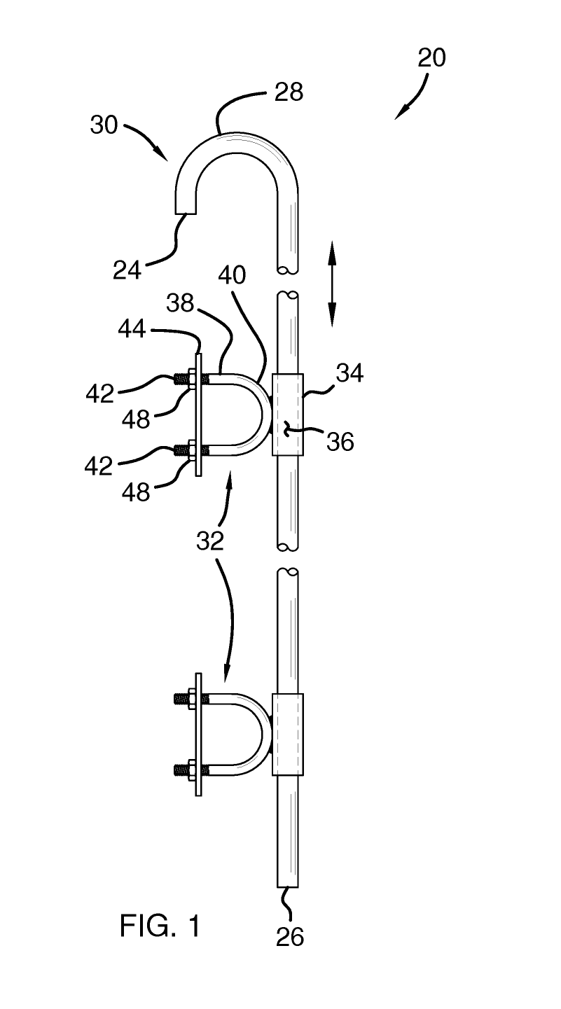

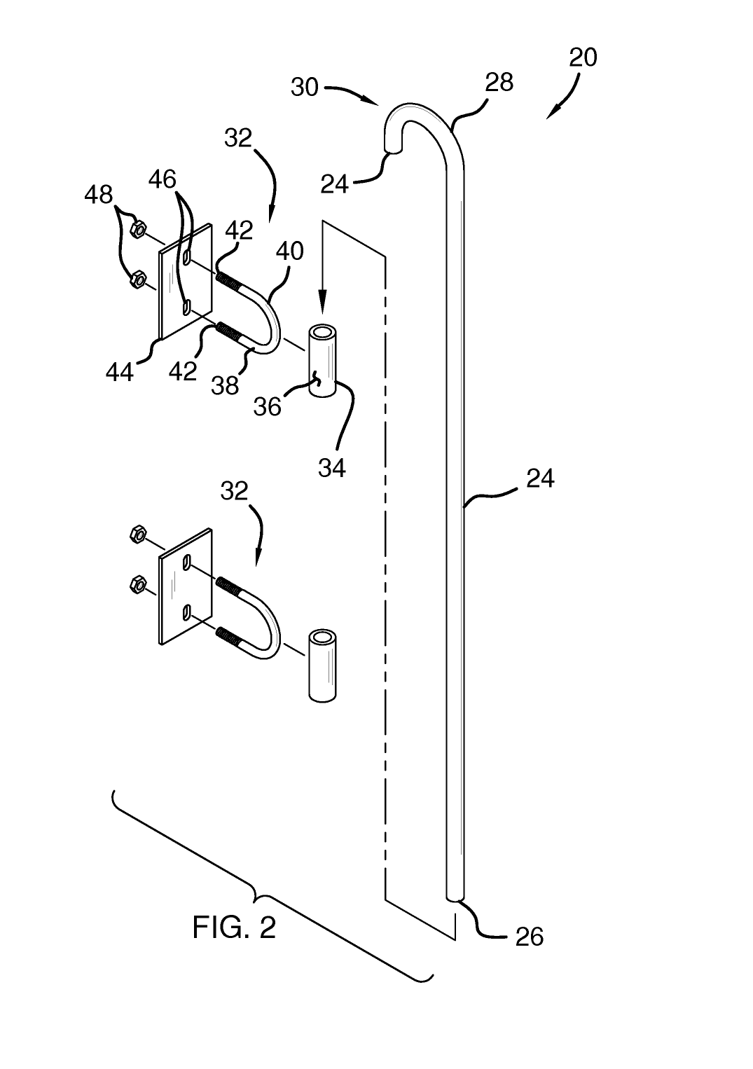

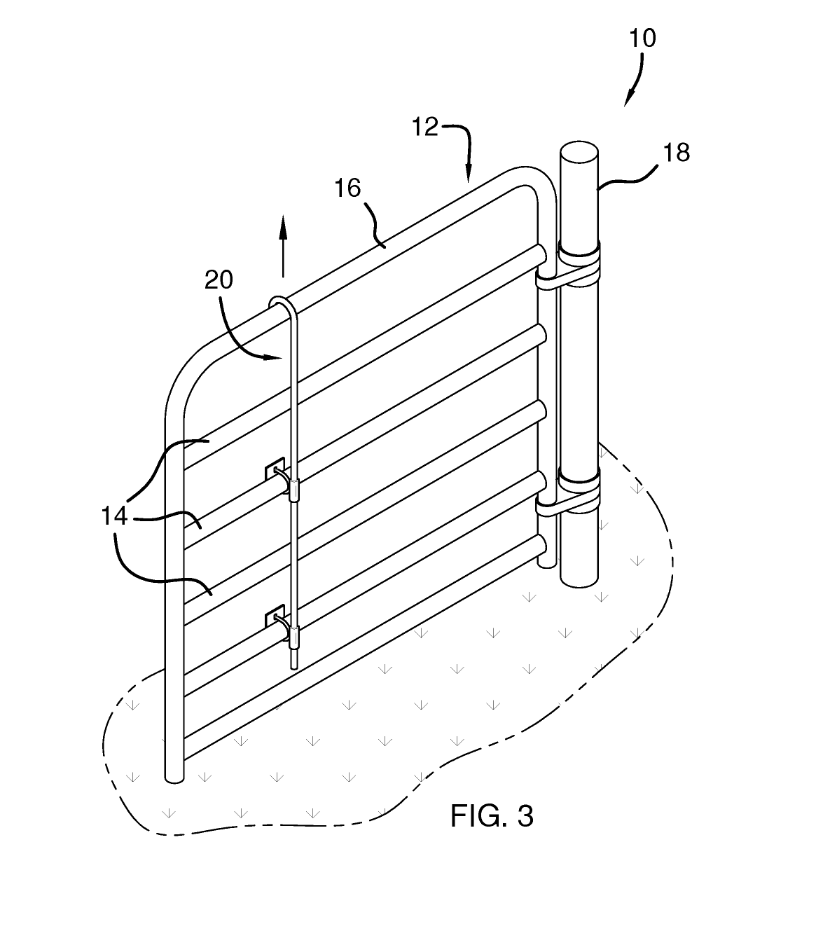

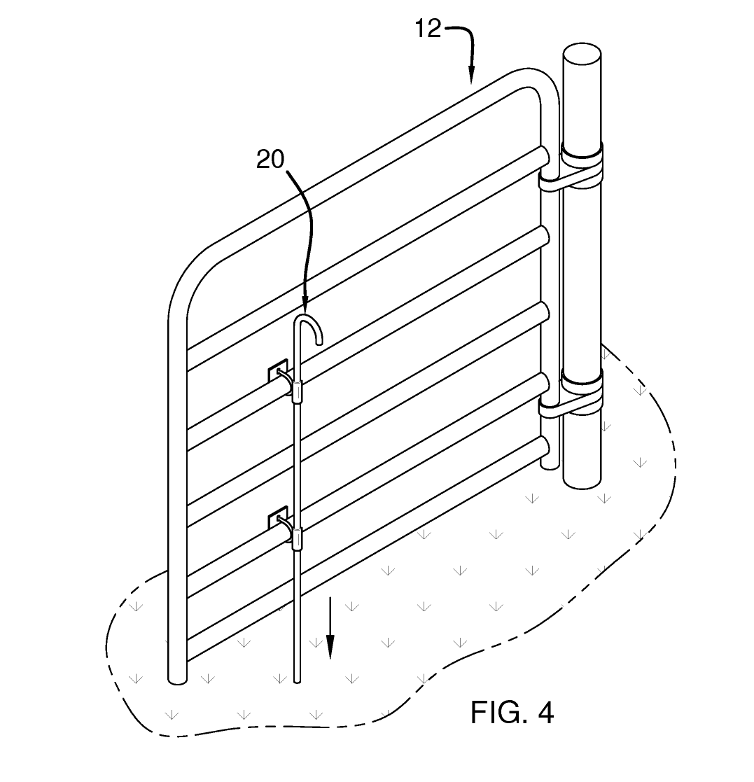

With reference now to the drawings, and in particular to FIGS. 1 through 4 thereof, a new locking device embodying the principles and concepts of an embodiment of the disclosure and generally designated by the reference numeral 10 will be described.

As best illustrated in FIGS. 1 through 4, the gate locking system 10 generally comprises a gate 12 that has a plurality of horizontal bars 14. The plurality of horizontal bars 14 includes a topmost bar 16. The gate 12 is hingedly coupled to a post 18. Moreover, the gate 12 is selectively positioned in an open position and a closed position. The gate 12 may be a livestock gate or the like.

A locking unit 20 is provided. The locking unit 20 is movably coupled to the gate 12. Thus, the locking unit 20 may be manipulated. The locking unit 20 selectively retains the gate 12 in the open position when the locking unit 20 is positioned in the locked position.

The locking unit 20 comprises a rod 22 that has a first end 24 and a second end 26. The rod 22 has a length of at least one hundred twenty cm. The rod 22 has a bend 28 thereon and the bend 28 is positioned closer to the first end 24 than the second end 26. Thus, the first end 24 is directed toward the second end 26 to define a hook 30.

A pair of couplers 32 is provided. Each of the couplers 32 is slidably coupled to the rod 22 and each of the couplers 32 is coupled to the gate 12. The couplers 32 are spaced apart from each other and distributed between the hook 30 and the second end 26. The rod 22 is positioned in a stored positioned having the hook 30 engaging the topmost bar 16. Thus, the second end 26 of the rod 22 is spaced from ground thereby facilitating the gate 12 to be manipulated into the open position. The rod 22 is positioned in a deployed position has the hook 30 disengaging the topmost bar 16. Thus, the second end 26 engages the ground thereby facilitating the rod 22 to retain the gate 12 in the open position.

Each of the couplers 32 comprises a sleeve 34 that has an outer surface 36. The rod 22 extends 42 through the sleeve 34. Thus, the sleeve 34 is slidably positioned on the rod 22. The sleeve 34 is positioned between the hook 30 and the second end 26.

A u-bolt 38 is provided and the u-bolt 38 has a bend 40 and a pair of ends 42. The bend 28 is coupled to the outer surface 36 of the sleeve 34. Moreover, the u-bolt 38 is positioned around an associated one of the horizontal bars 14 on the gate 12. Thus, the rod 22 is slidably positioned on the gate 12. The u-bolt 38 is threaded adjacent each of the ends 42. The u-bolt 38 may be welded to the sleeve 34.

A plate 44 is provided. The plate 44 has as a pair of apertures 46 extending therethrough. Each of the ends 42 of the u-bolt 38 extends through an associated one of the apertures 46 in the plate 44. The plate 44 abuts the associated horizontal bar 14. Thus, the associated horizontal bar 14 is retained in the u-bolt 38.

A pair of nuts 48 is provided. Each of the nuts 48 threadably engages an associated one of the ends 42 on the u-bolt 38. The plate 44 is compressed against the associated horizontal bar 14. Thus, the associated horizontal bar 14 is retained in the u-bolt 38.

In use, the rod 22 is manipulated into the stored position. Thus, the gate 12 swings freely on the post 18. Moreover, the gate 12 is positioned in the closed position when the rod 22 is positioned in the stored position. The gate 12 is manipulated into the open position and the rod 22 is manipulated into the deployed position. Thus, the rod 22 retains the gate 12 in the open position. The rod 22 facilitates a vehicle to be moved through the gate 12 without having to dismount the vehicle to open the gate 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. (canceled)

3. (canceled)

4. (canceled)

5. (canceled)

6. (canceled)

7. (canceled)

8. (canceled)

9. A gate locking system comprising:
a gate having a plurality of horizontal bars, said plurality of horizontal bars including a topmost bar, said gate being hingedly coupled to a post, said gate being selectively positioned in an open position and a closed position; and
a locking unit being movably coupled to said gate wherein said locking unit is configured to be manipulated, said locking unit selectively retaining said gate in said open position, said locking unit comprising:
a rod having a first end and a second end, said rod having a length of at least one hundred twenty cm, said rod having a bend thereon, said bend being positioned closer to said first end than said second end, said first end being directed toward said second end to define a hook,
a pair of couplers, each of said couplers being slidably coupled to said rod, each of said couplers being coupled to said gate, said rod being positioned in a stored positioned having said hook engaging said topmost bar wherein said second end of said rod is configured to be spaced from ground thereby facilitating said gate to be manipulated into said open position, said rod being positioned in a deployed position having said hook disengaging said topmost bar wherein said second end is configured to engage ground thereby facilitating said rod to retain said gate in said open position, each of said couplers comprising:
a sleeve having an outer surface, said sleeve being elongated, said sleeve having said rod extending therethrough such that said sleeve is slidably positioned on said rod, said sleeve being positioned between said hook and said second end,
a u-bolt having a bend and a pair of ends, said bend of said u-bolt being coupled to said outer surface of said sleeve such that said u-bolt extends radially from a central axis extending through said sleeve wherein said central axis of said sleeve is coplanar with said u-bolt, said u-bolt being positioned around an associated one of said horizontal bars on said gate such that said rod is slidably positioned on said gate, said u-bolt being threaded adjacent each of said ends,
a plate having a pair of apertures extending therethrough, each of said ends of said u-bolt extending through an associated one of said apertures in said plate, said plate abutting said associated horizontal bar such that said associated horizontal bar is retained in said u-bolt, and
a pair of nuts, each of said nuts threadably engaging an associated one of said ends on said u-bolt having said plate being compressed against said associated horizontal bar such that said associated horizontal bar is retained in said u-bolt.
